(19) United States
(12) Patent Application Publication
(10) Pub. No.: US 2017/0087971 A1
(43) Pub. Date: Mar. 30, 2017

(54) Vehicle Covering Device

(71) Applicant: Edith Hall, Rochester, NY (US)

(72) Inventor: Edith Hall, Rochester, NY (US)

(21) Appl. No.: 14/871,261

(22) Filed: Sep. 30, 2015

(51) Int. Cl. B60J 11/04

(52) U.S. Cl. CPC B60J 11/04

(57) ABSTRACT

A vehicle covering device for covering the top surfaces of a vehicle includes a panel that is flexible and sized to cover the top surfaces of a vehicle. Each of a plurality of extensions is flexible and has a first end and a second end. The first ends are coupled to opposing sides of the panel. Each of a plurality of weights is coupled to a respective second end of the extensions.

### BACKGROUND OF THE DISCLOSURE

### Field of the Disclosure

The disclosure relates to covering devices and more particularly pertains to a new covering device for covering the top surfaces of a vehicle.

### SUMMARY OF THE DISCLOSURE

An embodiment of the disclosure meets the needs presented above by generally comprising a panel that is flexible and sized to cover the top surfaces of a vehicle. Each of a plurality of extensions is flexible and has a first end and a second end. The first ends are coupled to opposing sides of the panel. Each of a plurality of weights is coupled to a respective second end of the extensions.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is an isometric perspective view of a vehicle covering device according to an embodiment of the disclosure.

FIG. 2 is a top view of an embodiment of the disclosure.

FIG. 3 is a side in-use view of an embodiment of the disclosure.

FIG. 4 is a back in-use view of an embodiment of the disclosure.

FIG. 5 is a cross-sectional view of an embodiment of the disclosure.

### DESCRIPTION OF THE PREFERRED EMBODIMENT

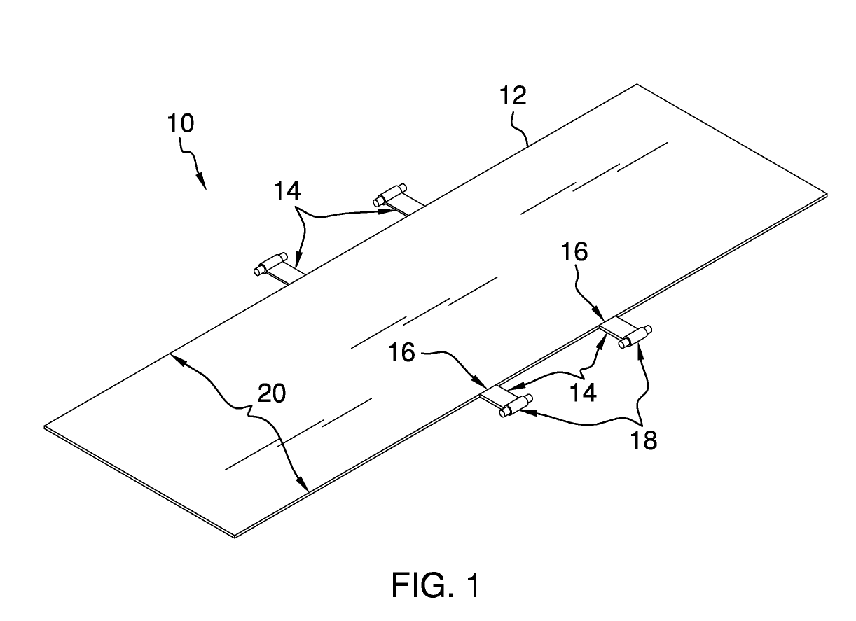

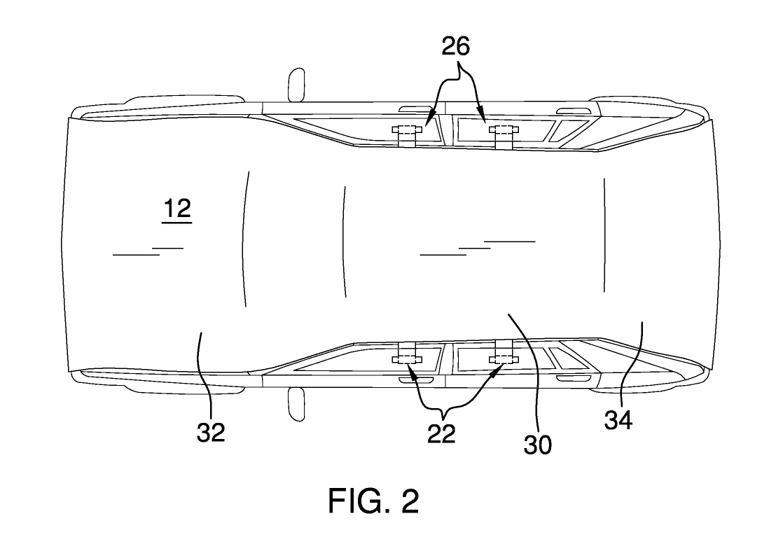

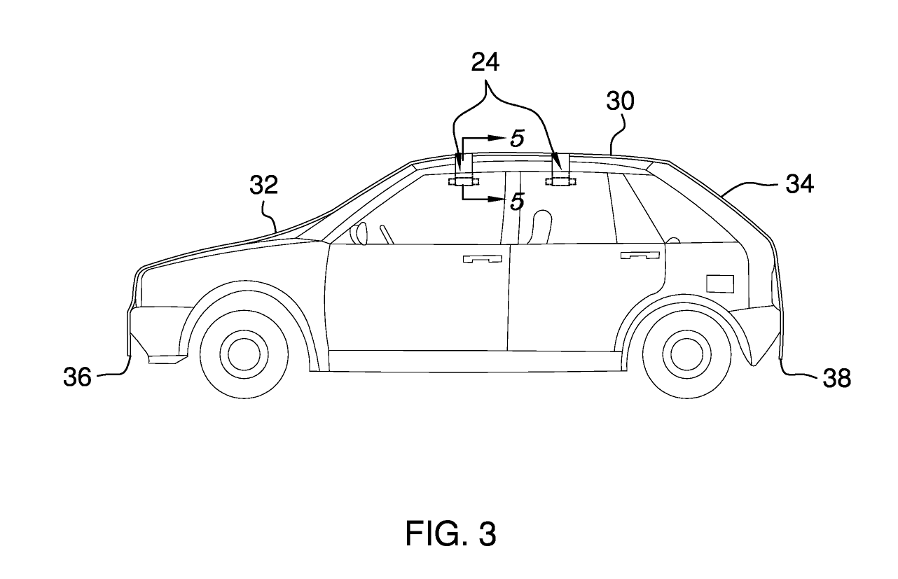

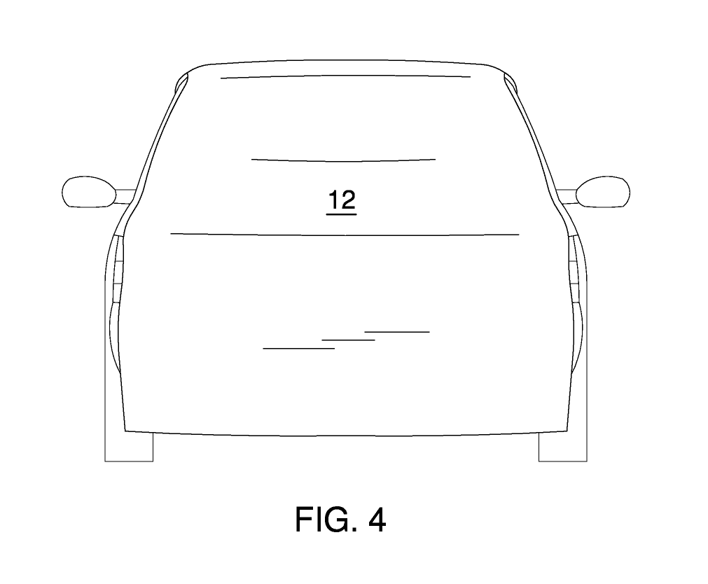

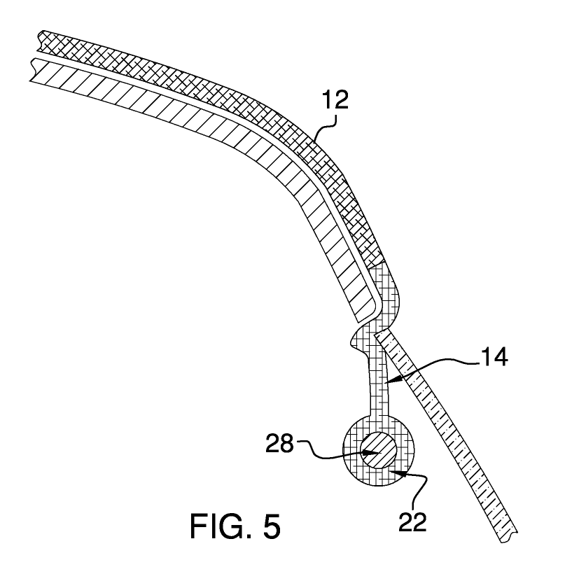

With reference now to the drawings, and in particular to FIGS. 1 through 5 thereof, a new covering device embodying the principles and concepts of an embodiment of the disclosure and generally designated by the reference numeral 10 will be described.

As best illustrated in FIGS. 1 through 5, the vehicle covering device 10 generally comprises a panel 12 that is flexible and sized to cover the top surfaces of a vehicle. The panel 12 comprises canvas and is shaped to correspond to the top surfaces of the vehicle. Thus, the panel may have a medial section 30 which is substantially rectangular and a pair of outer sections 32,34 which are tapered inwardly extending from a respective distal edge 36,38 to cover the front and back windows and hood and trunk of the vehicle. Each of a plurality of extensions 14 is flexible and has a first end 16 and a second end 18. The first ends 16 are coupled to opposing sides 20 of the panel 12. The second ends 18 comprise sleeves 22. The plurality of extensions 14 is numbered equally on both of the opposing sides 20. The plurality of extensions 14 comprises strips 24. The strips 24 comprise canvas. The plurality of extensions 14 comprises two extensions positioned on each of the opposing sides 20. The plurality of extensions 14 is positioned on the opposing edges 20 such that the extensions 14 align with the windows of the vehicle. Each of a plurality of weights 26 is coupled to a respective second end 18 of the extensions 14. The weights 26 comprise rods 28, with each of the rods 28 positioned in and frictionally coupled to a respective one of the sleeves 22.

In use, the panel 12 is positionable on the user's vehicle with the strips 24 positioned proximate to the vehicles open windows, such that the weights 26 cause the strips 24 to enter the window opening and the user can close the vehicle windows to secure the panel 12 to the vehicle.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A vehicle covering device comprising:
a panel, said panel being flexible, said panel being sized to cover the top surfaces of a vehicle;
a plurality of extensions, said extensions being flexible, each of said extensions having a first end and a second end, said first ends being coupled to opposing sides of said panel; and
a plurality of weights, each of said weights being coupled to a respective second end of said extension.

2. The device of claim 1, further including said panel comprising canvas.

3. The device of claim 1, further including said panel having a rectangular medial section and a pair of outer sections tapering extending towards said medial section from a respective distal edge of said panel relative to said medial section.

4. The device of claim 1, further comprising:
said second ends comprising sleeves; and
said weights comprising rods, each said rod being positioned in and frictionally coupled to a respective one of said sleeves.

5. The device of claim 1, further including said plurality of extensions being numbered equally on both of said opposing sides.

6. The device of claim 1, further including said plurality of extensions comprising strips, said strips comprising canvas.

7. The device of claim 1, further including said plurality of extensions comprising two extensions positioned on each of said opposing sides.

8. The device of claim 1, further including said plurality of extensions being positioned on said opposing edges such that said extensions align with the windows of the vehicle.

9. A vehicle covering device comprising:
a panel, said panel being flexible, said panel being sized to cover the top surfaces of a vehicle, said panel comprising canvas, said panel having a rectangular medial section and a pair of outer sections tapering extending towards said medial section from a respective distal edge of said panel relative to said medial section;
a plurality of extensions, said extensions being flexible, each of said extensions having a first end and a second end, said first ends being coupled to opposing sides of said panel, said second ends comprising sleeves, said plurality of extensions being numbered equally on both of said opposing sides, said plurality of extensions comprising strips, said strips comprising canvas, said plurality of extensions comprising two extensions positioned on each of said opposing sides, said plurality of extensions being positioned on said opposing edges such that said extensions align with the windows of the vehicle;
a plurality of weights, each of said weights being coupled to a respective second end of said extension, said weights comprising rods, each said rod being positioned in and frictionally coupled to a respective one of said sleeves; and
wherein said panel is positionable on the user's vehicle with said strips being positioned proximate to the vehicles open windows, such that said weights cause said strips to enter the window opening, wherein the user can close the vehicle windows to secure said panel to the vehicle.
